(19) United States
(12) Patent Application Publication
(10) Pub. No.: US 2019/0246835 A1
(43) Pub. Date: Aug. 15, 2019

(54) AIR FRYER OVEN

(71) Applicant: KE M.O. HOUSE CO., LTD, Shengzhen (CN)

(72) Inventor: Mo-Tsan TSAI, New Taipei City (TW)

(21) Appl. No.: 16/260,676

(22) Filed: Jan. 29, 2019

(30) Foreign Application Priority Data
Feb. 13, 2018 (CN) 201820257871.5

(51) Int. Cl. A47J 37/06

(52) U.S. Cl. CPC A47J 37/0641; A47J 37/0664

(57) ABSTRACT

An air fryer oven comprising a housing and a food rack is disclosed. The housing comprises an air fryer chamber which includes two opposite side walls and each side wall is provided with a bracket, respectively. The housing is provided with an air fryer heating module, disposed above the air fryer chamber; and a drive motor, detachably joined to one end of the food rack to rotate the food rack. The two ends of the food rack are directly placed on the brackets as the brackets can support one end of the food rack so that the food rack can be removed from the air fryer chamber and loaded with food. The air fryer heating module can generate heat and cause air flow circulation to process the food. Through rotating the food rack by the drive motor, every part of the food on the food rack can be heated evenly, and provide a rotisserie grilling function at the same time.

### CROSS REFERENCE

This non-provisional application claims priority of China Patent Application NO. 201820257871.5 filed on Feb. 13, 2018, the content thereof is incorporated by reference herein.

### BACKGROUND OF THE INVENTION

### Field of the Invention

The present invention relates to the field of kitchen appliances, and more specifically to an oven that utilizes hot air to cook food.

### Description of the Prior Art

Conventional air fryer ovens usually heat each part of the food in a pot by controlling the air flow. However, some parts of the food (e.g. the bottom area of the food) that cannot be effectively heated, resulting in uneven cooking of the food.

As a result, the unevenly cooked food is not appealing and can even be harmful to one's health if not cooked adequately.

### SUMMARY OF THE INVENTION

It is an objective of the present invention to provide an air fryer oven which ensures that food is heated evenly.

In order to achieve the above objective and more, the present invention provides an air fryer oven, comprising a housing and a food rack. The housing comprises an air fryer chamber to process foods. The air fryer chamber includes two opposite side walls and each of the side walls is equipped with a bracket. The two ends of the food rack are placed on the two brackets, respectively. The housing further comprises an air fryer heating module, disposed above the air fryer chamber; and a drive motor, disposed on one side wall, wherein the drive motor detachably connects with one end of the food rack to rotate the food rack in a rotisserie manner. The axis of rotation of the food rack is horizontal in orientation.

The bracket is bar-shaped, wherein the longitudinal direction is horizontal, and is perpendicular to the axis of rotation of the food rack.

The two ends of the bracket are fixed on the side wall. A gap is formed between the middle of the bracket and the side wall.

The brackets are plank shaped, wherein the plank surface is vertical. The brackets can also be rod shaped.

The two side walls comprise a first side wall and a second side wall. The bracket on the first side wall is a first bracket, and the bracket on the second side wall is a second bracket. The first bracket includes a notch. One end of the food rack is rotationally disposed in the notch. The drive motor is disposed on the second side wall. The second bracket is provided with a limiting bump disposed relatively to the drive motor for the purpose of limiting the position of the other end of the food rack.

The food rack comprises a rack main body and two connecting ends. The two connecting ends are respectively fixed to the two ends of the rack main body. Both connecting ends have the same structure which is pillar shaped. The two connecting ends can be placed on the two brackets, respectively. The connecting end can detachably connect to the drive motor.

The connecting end comprises a first limiting block, a cylinder, and a second limiting block. The first limiting block and the second limiting block are disposed on the two ends of the cylinder. A cyclic limiting slot is formed between the first limiting block and the second limiting block. The slot bottom of the limiting slot is the surface of the cylinder. The bracket can extend into the limiting slot and abut on the cylinder.

The output shaft of the drive motor is provided with an adaptor bushing. The adaptor bushing slidably connects to the output shaft of the drive motor along an axis, and the two are positioned circumferentially. The other end of the food rack comprises a transmission shaft. While the adaptor bushing slides to a first position, the adaptor bushing caps the transmission shaft, and the transmission shaft and the adaptor bushing are positioned circumferentially. When the adaptor bushing slides to a second position, the adaptor bushing and the transmission shaft are separated from each other.

The rack main body comprises a metal rotary cage, an end plate, and an end cap. The end plate fixedly connects to one end of the metal rotary cage, and the end cap detachably covers the other end of the metal rotary cage. The two connecting ends fixedly connect to the surfaces of the end plate and the end cap, respectively.

The housing is equipped with a trigger module used for driving the adaptor bushing to slide. The trigger module comprises a trigger element and a torsional spring. The middle of the trigger element rotarily links to the housing, and one end of the trigger element links to the adaptor bushing. While the trigger element rotates, the trigger element impels the adaptor bushing to slide. The torsional spring is arranged between the trigger element and the housing, and is used to cause the rotation of the trigger element and maintain the adaptor bushing in the first position.

The present invention has the advantages and benefits as follows: both of the two ends of the food rack are placed directly on the brackets as the bracket can support one end of the food rack so that the food rack can be pulled out from the air fryer chamber and loaded with food. The air fryer heating module can generate heat and air flow circulation to process the food. The drive motor rotates the food rack in order to heat every part of the food on the food rack evenly and provide a rotisserie grilling function at the same time.

### BRIEF DESCRIPTION OF THE DRAWINGS

In order to more clearly illustrate the technical solutions of the embodiments of the present invention, the drawings used in the embodiments will be briefly described below. Obviously, the drawings in the following description are only some embodiments of the present invention, and a person having ordinary skilled in the art can obtain other drawings according to these drawings without any creative work.

FIG. 1 is a schematic view of a prefer embodiment of the air fryer oven the present invention;

FIG. 2 is a perspective view of the air fryer oven in FIG. 1;

FIG. 3 is a perspective view of the air fryer oven in FIG. 1, from another angle;

FIG. 4 is a schematic view of a part of the air fryer oven in FIG. 1;

FIG. 5 is a perspective schematic view of the air fryer oven in FIG. 1; and

FIG. 6 is a schematic view of another embodiment of the food rack of the present invention.

### DETAILED DESCRIPTION OF THE EMBODIMENTS

Features and functions of the technical means and structures applied to the present invention to achieve the aforesaid objectives and effects are depicted by the drawings, illustrated with preferred embodiments, and described below so as to be fully comprehensible but not restrictive of the present invention.

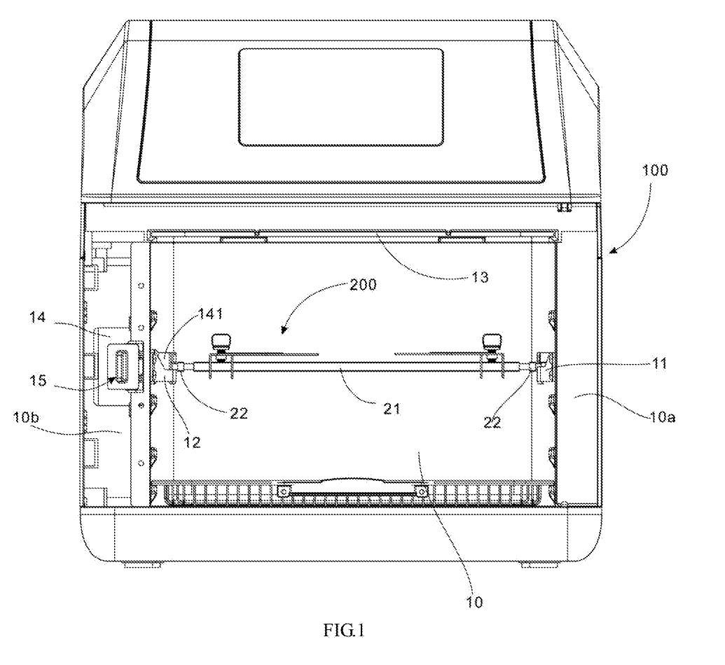

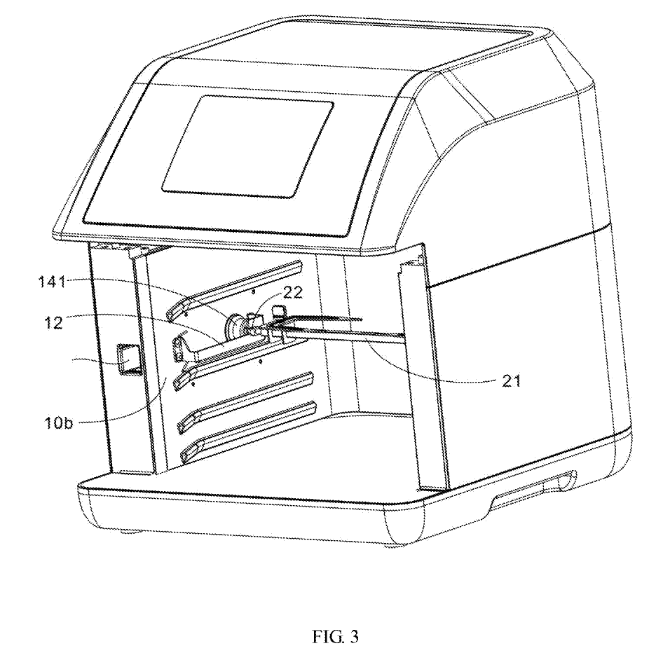

FIG. 1 to FIG. 3 illustrate an air fryer oven of preferred embodiments of the present invention. The air fryer oven includes a housing 100 and a food rack 200. The housing 100 has an air fryer chamber 10 to process foods. The food rack 200 can be loaded with various kinds of food and is then placed into the air fryer chamber 10 for processing the foods. A door element (not shown in the drawings) is hinged on the housing 100 to allow the air fryer chamber 10 to be opened so that one can put in or take out the food rack 200.

The air fryer chamber 10 comprises two opposite side walls 10a and 10b, and each of the two side walls 10a and 10b are equipped with brackets 11 and 12. The two ends of the food rack 200 are directly placed on the two brackets 11 and 12 as the brackets 11 and 12 can support one end of the food rack 200 so that the food rack 200 can be pulled out from the air fryer chamber 10 and loaded with food.

The housing 100 comprises an air fryer heating module 13 and a drive motor 14. The air fryer heating module 13 is arranged above the air fryer chamber 10. The air fryer heating module 13 can generate heat and cause air flow circulation in order to process the food.

The drive motor 14 is disposed on the side walls 10a or 10b. The drive motor 14 detachably connects to one end of the food rack 200 to rotate the food rack 200. The axis of rotation of the food rack 200 is horizontal in orientation. The drive motor 14 rotates the food rack 200 in order to evenly heat every part of the food on the food rack 200 and provide a rotisserie grilling function at the same time.

For ease of the description, the two side walls 10a and 10b are described as the first side wall 10a and the second side wall 10b; the bracket on the first side wall 10a is the first bracket 11 and the bracket on the second side wall 10b is the second bracket 12.

The first bracket 11 and the second bracket 12 are bar shaped, wherein the longitudinal direction is horizontal, and is perpendicular to the axis of rotation of the food rack 200. The long sides of the first bracket 11 and the second bracket 12 can act as a slide, to allow the food rack 200 to slide from the entrance of the air fryer oven to a rotation position and thus be easily pulled out and put in.

The two ends of the first bracket 11 and the second bracket 12 are fixedly connected to the side walls 10a and 10b. A gap is formed between the middle of the brackets and the side walls 10a and 10b. The gap can be used to make room for the end part of the food rack 200 to slide.

A notch 110 is formed on the first bracket 11. One end of the food rack 200 is rotationally disposed in the notch 110. The notch 110 can limit the position of one end of the food rack 200 for the sake of easy rotation. During use, one end of the food rack 200 is placed in the notch 110 of the first bracket 11, and for removal, the food rack 200 is lifted up and pulled out. In this way, the food rack 200 and the first side wall 10a can be detachably and rotationally connected.

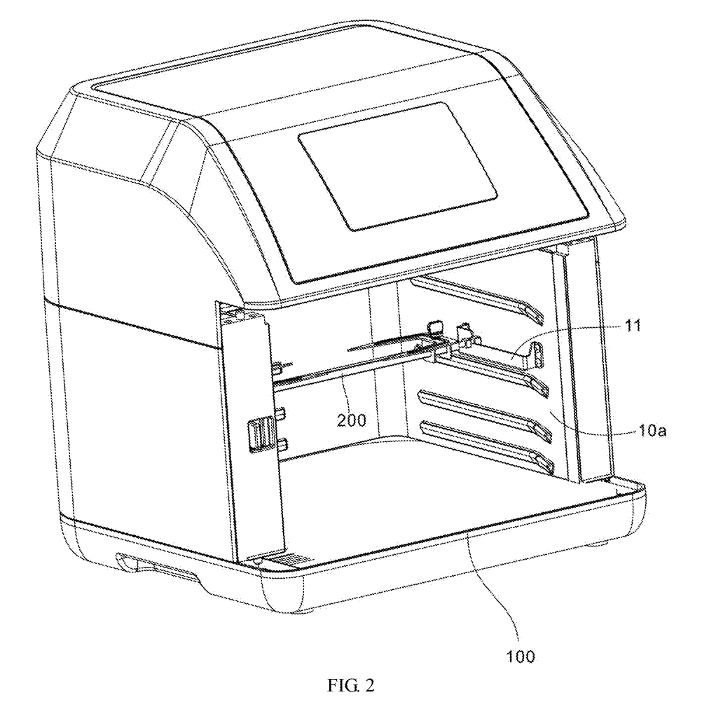

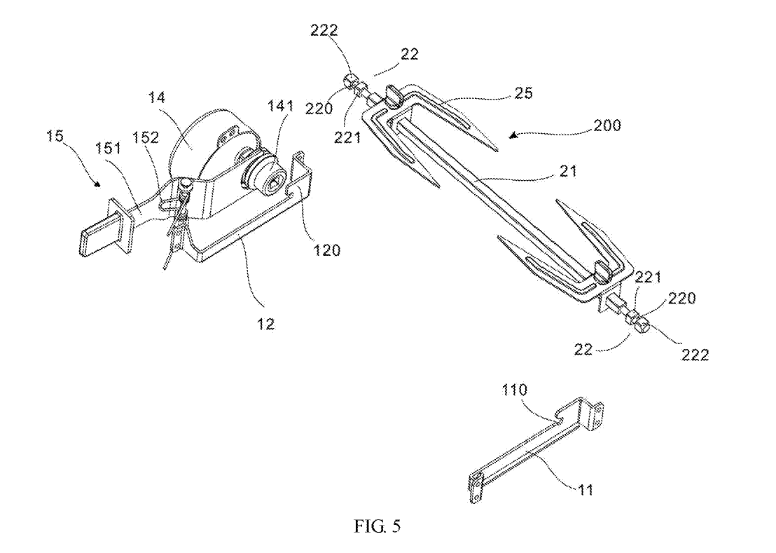

As shown in FIG. 2, more specifically, the first bracket 11 is plank shaped, wherein the plank surface is vertical. The two ends of the first bracket 11 are fixed to the first side wall 10a. As shown in FIG. 5, the upper side of the first bracket 11 dips in to form the notch 110. When removing or loading the food rack 200, the food rack can slide along the long side of the first bracket 11 in order to place one end of the food rack 200 into the notch 110. Furthermore, in other embodiments, the first bracket 11 can be rod-shaped, wherein the axis of the first bracket is perpendicular to the axis of rotation of the food rack 200. The two ends of the first bracket 11 are fixed to the first side wall 10a. The first bracket 11 slots downward to form the notch 110.

As shown in FIG. 1, the drive motor 14 is arranged on the second side wall 10b. As shown in FIG. 5, the second bracket 12 forms a limiting bump 120, which is adjacent to the drive motor 14 to limit the position of the other end of the food rack 200, providing a mating connection between this end of the food rack and the drive motor 14. In this embodiment, the second bracket 12 is also plank shaped, wherein the plank surface is vertical. In other embodiments, the second bracket 12 can also be rod-shaped.

In the above embodiments, both the first bracket 11 and the second bracket 12 can be plank-shaped or rod-shaped. In other embodiments, the first bracket 11 and the second bracket 12 can be a rib structure formed by a protrusion on the side walls 10a and 10b into the air fryer chamber 10.

As shown in FIG. 5, the food rack 200 comprises a rack main body 21 and two connecting ends 22. The rack main body 21 is used for holding foods, and the two connecting ends 22 are used for inserting the food rack 200 into the air fryer chamber 10. The two connecting ends 22 are placed on the first bracket 11 and the second bracket 12, respectively, wherein one end of the connecting ends 22 is detachably connected with the drive motor 14 in order to rotate the whole food rack 200.

The two connecting ends 22 have the same structure and are, for example, pillar, square, or rectangularly shaped. In this way, either of the two ends of the food rack 200 can couple to the drive motor 14 in order to allow the food rack 200 to be easily inserted into the air fryer chamber 10. Furthermore, in other embodiments, the structures of the two connecting ends 22 can be different.

The connecting end 22 comprises a first limiting block 221, a cylinder 220, and a second limiting block 222. The first limiting block 221 and the second limiting block 222 are disposed on the two ends of the cylinder 220. The second limiting column 222 is disposed away from the rack main body 21, relative to the first limiting column 221. A cyclic limiting slot is formed between the first limiting block 221 and the second limiting block 222. The slot bottom of the limiting slot is the surface of the cylinder 220. The first bracket 11 and the second bracket 12 can extend into the limiting slot and abut on the cylinder 220. The arcuate surface of the cylinder 220 works in association with the first bracket 11 or the second bracket 12 to rotate the food rack 200. The first bracket 11 or the second bracket 12 can lodge in the limiting slot by positioning the first limiting block 221 and the second limiting block 222 on the two sides of the first bracket 11 or the second bracket 12, respectively, in order to limit the longitudinal position of the food rack 200 in the air fryer chamber 10. The second limiting block 222 can detachably connect with the drive motor 14.

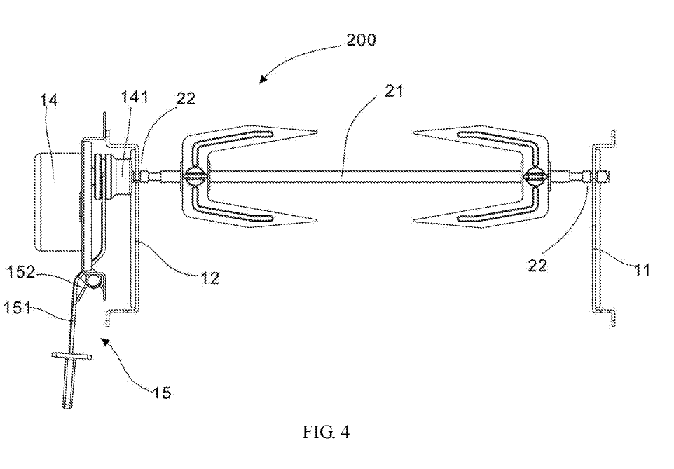

As shown in FIG. 4 and FIG. 5, the output shaft of the drive motor 14 is equipped with an adaptor bushing 141. The adaptor bushing 141 slidably connects to the output shaft of the drive motor 14 along an axis, and the two are circumferential positioned. When the adaptor bushing 141 slides to a first position, the adaptor bushing 141 caps the connecting end 22, and the connecting end 22 and the adaptor bushing are circumferential positioned. When the adaptor bushing 141 slides to a second position, the adaptor bushing 141 and the connecting end 22 separate from each other. Utilizing the sliding adaptor bushing 141, the drive motor 14 and the food rack 200 can be connected detachably and easy to operate. Moreover, in other embodiments, the drive motor 14 and the food rack 200 can be detachably connected through other methods, such as a locking and socket structure.

Specifically, in the present embodiment, the adaptor bushing 141 and the second limiting block 222 of the connecting end 22 connect to each other. Furthermore, the second limiting block 222 is, for example, square column shaped; the adaptor bushing 141 comprises a square hole with which the square column is in associated to circumferentially position the second limiting block 222. Alternatively, the second limiting block 222 is, for example, triangular column shaped and the adaptor bushing 141 comprises a triangular hole. The adaptor bushing 141 and the second limiting block 222 can associate with each other via other shapes, and are positioned circumferentially. Similarly, the output shaft of the drive motor 14 and the adaptor bushing 141 can associate with each other via square column and a square hole.

The housing 100 is equipped with a trigger module 15 used for driving the adaptor bushing 141 to slide in order to remove or insert the food rack 200. The trigger module 15 can be an electric trigger module 15 which uses an electromagnetic mechanism to drive the adaptor bushing 141 to slide or uses an air cylinder or gas to achieve a linear movement. The trigger module 15 can also be a manual mechanism structure in which a user applies a force to the trigger module 15 to make the adaptor bushing 141 slide.

In the present embodiment, the trigger module 15 includes a trigger element 151 and a torsional spring 152. The middle of the trigger element 151 rotarily links to the housing 100, and one end of the trigger element 151 links to the adaptor bushing 141. When the trigger element 151 rotates, the trigger element 151 drives the adaptor bushing 141 to slide. The torsional spring 152 is disposed between the trigger element 151 and the housing 100, and is used to cause the trigger element 151 to rotate and maintain the adaptor bushing 141 in a first position. When taking out or loading the food rack device, a user toggles the outer end of the trigger element 151 to rotate the trigger element 151, and the inner end of the trigger element 151 will then drive the adaptor bushing 141 to slide. In this way, the adaptor bushing 141 and the second limiting block 222 of the food rack 200 separate from each other. At this time, the food rack 200 can be removed from or put into the air fryer chamber 10. The torsional spring 152 can revert the trigger element 151 to the original state so that the adaptor bushing 141 can be maintained in the first position without additional force from a user. The adaptor bushing 141 and the second limiting block 222 are maintained in a connected state so that the drive motor 14 will rotate the food rack 200. In other embodiments, the trigger module 15 comprises a trigger element 151 and a spring. The trigger element 151 slidably connects to the housing 100; the spring is arranged between the trigger element 151 and the housing 100 to provide a force to make the trigger element 151 slide and hence maintain the adaptor bushing 141 in the first position. When removing or inserting the food rack, a user pushes the trigger element 151 to move the adaptor bushing 141 to a second position.

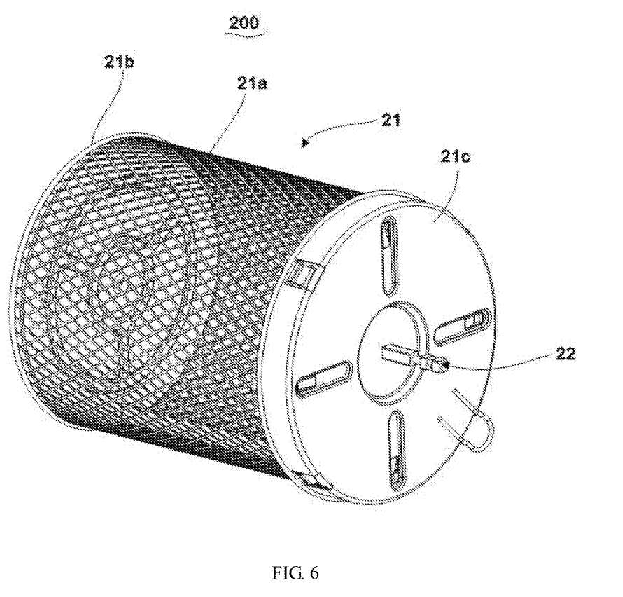

In the present embodiment, the rack main body 21 of the food rack 200 can be rod shaped, comprising a fork 25 to stabilize foods. In other embodiment, the main body 21 of the food rack 200 is a metal rotary cage. As shown in FIG. 6, the main body 21 comprises a metal rotary cage 21a, an end plate 21b, and an end cap 21c. The end plate 21b fixedly connects to one end of the metal rotary cage 21a, and the end cap 21b detachably caps the other end of the metal rotary cage 21a. The two connecting ends 22 fixedly connect to the surfaces of the end plate 21b and the end cap 21c, respectively. The foods can be loaded in the metal rotary cage 21a. During use, the end cap 21c is opened and the food to be processed is loaded into the space formed between the metal rotary cage 21a and the end plate 21b. The end cap 21c is then closed, and the entire food rack 200 is placed onto the first bracket and the second bracket in the air fryer chamber. During the processing, the thermal energy can flow into the interior through the lattice structure of the metal rotary cage 21a and allow the heating process. The foods roll in the metal rotary cage 21a for evenly heating under the operation of the drive motor 14. The specific structure of the food rack is not limited to the above described embodiments. In other embodiments, the food rack 200 can also be any other shapes that are able to contain foods.

The above embodiments and illustrations do not limit the product form and style of the present invention. Any suitable changes and modifications made by any person skilled in the art will be deemed as falling within the patent scope of the present invention.

What is claimed is:

1. An air fryer oven, comprising a housing and a food rack, wherein the housing comprises:
an air fryer chamber for processing foods, comprising two opposite side walls and each of the side walls is provided with a bracket, and two ends of the food rack are placed on the two brackets, respectively;
an air fryer heating module, arranged above the air fryer chamber; and
a drive motor, disposed on one of the side walls, wherein the drive motor and one end of the food rack are detachably connected to impel the food rack to rotate,
wherein the axis of rotation of the food rack is horizontal.

2. The air fryer oven according to claim 1, wherein
the bracket is bar shaped, and the longitudinal direction is horizontal and is perpendicular to the axis of rotation of the food rack.

3. The air fryer oven according to claim 2, wherein
the two ends of the bracket are fixed on the side wall; and
a gap is formed between the middle of the bracket and the side wall.

4. The air fryer oven according to claim 2, wherein the bracket is plank shaped and the plank surface is vertical; or the bracket is rod shaped.

5. The air fryer oven according to claim 1, wherein
the two side walls are a first side wall and a second side wall, the bracket on the first side wall is a first bracket, and the bracket on the second side wall is a second bracket;
the first bracket comprises a notch, and one end of the food rack is rotationally disposed in the notch;
the drive motor is disposed on the second side wall, the second bracket comprises a limiting bump disposed relatively to the drive motor to limit the position of the other end of the food rack.

6. The air fryer oven according to claim 1, wherein
the food rack comprises a rack main body and two connecting ends, the two connecting ends are relatively fixed to the two ends of the rack main body;
wherein, both of the two connecting ends are pillar shaped; and
the two connecting ends are placed on the two brackets, respectively, and the connecting end detachably connects to the drive motor.

7. The air fryer oven according to claim 6, wherein
the connecting end comprises a first limiting block, a cylinder, and a second limiting block, the first limiting block and the second limiting block are disposed on the two ends of the cylinder, a cyclic limiting slot is formed between the first limiting block and the second limiting block, and the slot bottom of the limiting slot is the surface of the cylinder;
wherein the bracket can extend into the limiting slot and abut the column.

8. The air fryer oven according to claim 6, wherein
the rack main body comprises a metal rotary cage, an end plate, and an end cap, the end plate fixedly connects to one end of the metal rotary cage, and the end cap detachably covers the other end of the metal rotary cage; and
the two connecting ends fixedly connect to the surfaces of the end plate and the end cap, respectively.

9. The air fryer oven according to claim 1, wherein
the output shaft of the drive motor is provided with an adaptor bushing, the adaptor bushing slidably connects to the output shaft of the drive motor along an axis, and the two are circumferentially positioned;
the other end of the food rack comprises a transmission shaft;
when the adaptor bushing slides to a first position, the adaptor bushing caps the transmission shaft, and the transmission shaft and the adaptor bushing are circumferential positioning; and
when the adaptor bushing slides to a second position, the adaptor bushing and the transmission shaft separate from each other.

10. The air fryer oven according to claim 8, wherein
the housing is equipped with a trigger module used for driving the adaptor bushing to slide;
the trigger module comprises a trigger element and a torsional spring, the middle of the trigger element rotarily links to the housing, one end of the trigger element links to the adaptor bush, and when the trigger element rotates, the trigger element drives the adaptor bushing to slide; and
the torsional spring is disposed between the trigger element and the housing and is used to cause the trigger element to rotate, and maintain the adaptor bushing in the first position.
